(19) United States
(12) Patent Application Publication
(10) Pub. No.: US 2009/0242548 A1
(43) Pub. Date: Oct. 1, 2009

(54) TAPE HEATER AND METHOD FOR MANUFACTURING THE SAME

(75) Inventors: Kenji Iida, Tokyo (JP); Keiichi Fukuda, Tokyo (JP); Akira Sasaki, Tokyo (JP); Daisaku Seki, Tokyo (JP); Emico Taguchi, Yamatokoriyama-shi (JP); Masayuki Kitamura, Komatsu-shi (JP)

Correspondence Address: NIXON & VANDERHYE, PC, 901 NORTH GLEBE ROAD, 11TH FLOOR, ARLINGTON, VA, 22203, US

(73) Assignees: NICHIAS CORPORATION, Tokyo (JP); THERMOS CORPORATION, Yamatokoriyama-shi (JP); HOKURIKU FIBER GLASS COMPANY, LIMITED, Komatsu-shi (JP)

(21) Appl. No.: 12/410,642

(22) Filed: Mar. 25, 2009

(30) Foreign Application Priority Data
Mar. 31, 2008 (JP) 2008-090706

(51) Int. Cl. H05B 3/34; D04B 1/22

(52) U.S. Cl. 219/529; 29/592.1

(57) ABSTRACT

The present invention relates to a tape heater including: at least one flexible fabric base formed from a heat-resistant thread, the at least one flexible fabric base including a first fabric base part and a second fabric base part; and a heater member, in which the heater member is interposed between the first fabric base part and the second fabric base pan. Since the heater member is interposed between the fabric base(s), the tape heater of the present invention exhibits superior flexibility and stretchability and is superior in easily being wrapped around a pipe, as well as reliably protecting the heater member. Further, tape heaters can be continually manufactured, so long as weaving or knitting of the fabric base(s) is caused to proceed while the heater member is interposed between the fabric base(s), to thus join the fabric base(s). Hence, enhancement of production efficiency and prevention of an increase in production cost can be attained.

### FIELD OF THE INVENTION

The present invention relates to a tape heater and a method for manufacturing the tape heater.

### BACKGROUND OF THE INVENTION

A tape heater has hitherto been used while being wrapped around a pipe, or the like, in order to heat or thermally insulate the pipe in a wrapped fashion for preventing freezing of the pipe or to hinder generation of byproducts, which would otherwise be caused as a result of cooling of exhaust gases emitted in various processes of manufacturing a semiconductor, in the semiconductor industry (see; for instance, JP-A-2004-303580 and JP-A-63-24582).

In the tape heater described in JP-A-2004-303580, a heating wire is disposed on a heat-resistant, strip-shaped flexible base material having electrical insulation and is stitched at predetermined intervals, to thus become fastened. Subsequently, the entirety of the heating wire is wrapped with a heat-resistant resin sheet.

In a tape heater described in JP-A-63-24582, carbon fibers coated with an electrically-insulative synthetic resin are taken as heating elements, and the heating elements are woven along with ordinary fibers into a strip shape.

### SUMMARY OF THE INVENTION

However, in the tape heater described in JP-A-2004-303580, after the heating wire has been fastened onto the base material, since the entirety of the heating wire is wrapped with a heat-resistant resin sheet, the heater cannot be manufactured continually, to thus result in poor productivity.

In the tape heater described in JP-A-63-24582, the heating elements are woven along with other fibers, and hence the heater can be manufactured continually, which leads to superior productivity. However, the heating elements are exposed through an exterior surface of the tape heater. Therefore, there is a concern that, if damage is inflicted on the tape heater, electrical insulation will be lost, thereby inducing shorts.

The present invention has been conceived in light of such drawbacks and aims at continually manufacturing a tape heater that reliably protects a heating member, that exhibits superior flexibility, stretch properties, and that is superior in easily being wrapped around a pipe.

In order to achieve the object, the present invention provides tape the following heaters and methods for manufacturing the heaters.

(1) A tape heater comprising:

at least one flexible fabric base formed from a heat-resistant thread, the at least one flexible fabric base comprising a first fabric base part and a second fabric base part; and

a heater member,

wherein the heater member is interposed between the first fabric base part and the second fabric base part.

(2) A tape heater comprising:

a flexible fabric base formed by weaving a heat-resistant thread; and

a heater member,

wherein the heater member is disposed in the fabric base.

(3) The tape heater according to (1), wherein the fabric base is woven or knitted tubular fabric.

(4) The tape heater according to (1), wherein the thread comprises heat-resistant inorganic fibers.

(5) The tape heater according to (2), wherein the thread comprises heat-resistant inorganic fibers.

(6) The tape heater according to (1), wherein the heater member is formed by sheathing a heating wire with an electrically-insulative sleeve.

(7) The tape heater according to (2), wherein the heater member is formed by sheathing a heating wire with an electrically-insulative sleeve.

(8) A method for manufacturing a tape heater comprising:

a step of forming at least one flexible fabric base by knitting or weaving a heat-resistant thread, the at least one flexible fabric base comprising a first fabric base part and a second fabric base part;

a step of interposing a heater member between the first fabric base part and the second base part; and

a step of joining the fabric base(s).

(9) A method for manufacturing a tape heater comprising:

a step of forming a flexible fabric base while weaving a heat-resistant thread and internally wrapping a heater member.

(10) The method for manufacturing a tape heater according to (8), the fabric base is woven or knitted tubular fabric.

(11) The method for manufacturing a tape heater according to (8), wherein knitting or weaving of the fabric base(s) is caused to proceed while the heater member is disposed, by continuously performing each of the steps.

(12) The method for manufacturing a tape heater according to (10), wherein knitting or weaving of the fabric base is caused to proceed while the heater member is disposed, by continuously performing each of the steps.

Since the heater member is interposed between the first fabric base part and the second fabric base part, the tape heater of the present invention exhibits superior flexibility and stretchability and is superior in easily being wrapped around a pipe, as well as reliably protecting the heater member. Further, tape heaters can be continually manufactured, so long as weaving or knitting of the fabric base(s) is caused to proceed while the heater member is interposed between the fabric base(s), to thus join the fabric base(s). Hence, enhancement of production efficiency and prevention of an increase in production cost can be attained.

### BRIEF DESCRIPTION OF THE DRAWINGS

FIG. 1A is a plan view showing a first embodiment of a tape heater of the present invention, and FIG. 1B is a cross-sectional view taken along line A-A in FIG. 1A;

FIG. 2A is a cross-sectional view of the tape heater shown in FIG. 1 taken along line B-B, FIG. 2B is a plan view achieved in direction B shown in FIG. 2A, and FIG. 2C is a plan view achieved in direction C in FIG. 2A;

FIG. 3 is a schematic view showing an apparatus for manufacturing the tape heater of the first embodiment;

FIG. 4 is a plan view showing a tape heater precursor produced by the apparatus shown in FIG. 3;

FIG. 5 is a cross-sectional view showing a second embodiment of the tape heater of the present invention as in FIG. 1B;

FIG. 6 is a schematic view showing an apparatus for manufacturing the tape heater of the second embodiment;

FIG. 7 is a cross-sectional view showing a third embodiment of the tape heater of the present invention as in FIG. 1B;

FIG. 8 is a schematic view showing an apparatus for manufacturing the tape heater of the third embodiment;

FIG. 9 is a cross-sectional view showing a tape heater of a fourth embodiment;

FIGS. 10A and 10B are cross-sectional views showing a tape heater of a fifth embodiment; and

FIG. 11 is a schematic view for describing another method for manufacturing a tape heater of the present invention.

### DESCRIPTION OF REFERENCE NUMERALS AND SIGNS

10, 10B, 10C, 10D and 10E TAPE HEATERS
10A and 10A′ TAPE HEATER PRECURSORS
11B DOUBLE-WIDTH FABRIC BASE
11C TUBULAR FABRIC BASE
11a FIRST FABRIC BASE PART
11b SECOND FABRIC BASE PART
12, 12A and 12B HEATER MEMBERS
13 THREAD

### DETAILED DESCRIPTION OF THE INVENTION

Embodiments of the present invention will be described hereunder in detail by reference to the drawings.

### First Embodiment

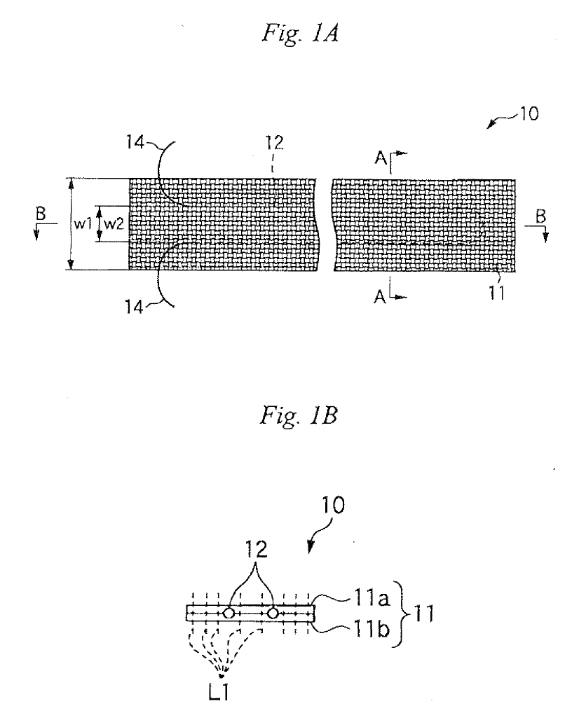

FIG. 1A is a plan view showing a first embodiment of a tape heater of the present invention, and FIG. 1B is a cross-sectional view taken along line A-A shown in FIG. 1A.

As illustrated, the tape heater 10 of the present embodiment of the present invention has a fabric base 11 including long lengths of first and second fabric base parts 11a and 11b made of a heat-resistant thread 13 and a heater member 12 sandwiched between the first and second fabric base parts 11a and 11b. Both brims of the first and second fabric base parts 11a and 11b having the heater member 12 sandwiched therebetween and areas between the brims are stitched at predetermined intervals along a longitudinal direction of the tape heater (see reference symbol L1 in FIG. 1B), thereby joining the fabric bases. Contacting of portions of the heater member 12, which would otherwise be caused by movement of the heater member in a widthwise direction, is prevented by stitching. Further, lead wires 14 and 14 to be connected to an external power source are drawn from end parts of the heater member 12. The fabric base parts 11a and 11b can also be formed by knitting operation of a conventional knitting machine or weaving operation of a conventional weaving machine.

In addition to having a heat resistance, glass fiber is easy to weave, has high strength, is inexpensively available in the market, and does not contain any volatile constituents; hence, the glass fiber is preferable for the thread 13. However, the thread can also be formed from heat-resistant inorganic fiber, such as ceramic fiber, silica fiber, and alumina fiber, or a heat-resistant resin, such as a fluorine resin. It is particularly important for a semiconductor manufacturing system that the thread does not contain volatile constituents responsible for outgassed contamination. A weaving pattern is not restricted to any particular pattern, and any pattern, such as a plain weaving pattern or a twill weaving pattern, is available. Moreover, a width W1 of the fabric base 11 is not restricted to any limitations and may be set to about 20 to 30 mm in consideration of ease of handling.

The heater member 12 is preferably sheathed with an electrically-insulative sleeve. For instance, a sleeve made by knitting a heating wire, such as a nichrome wire, with a heat-resistant inorganic fiber, such as ceramic fiber, silica fiber, alumina fiber, and glass fiber, or an element formed by sheathing the heating wire with an electrically-insulative resin, is used as the heater member. It is particularly preferable that a sheath made from a sleeve which is woven from heat-resistant inorganic fiber has a two-ply structure. Even if the tape heater 10 is bent or twisted when a worker wraps the tape heater around a pipe, the potential risk of the heating wire projecting from a mesh of the sleeve is eliminated by doubly sheathing the heating wire with the sleeve, so that electrical insulation can be assured without fail.

In the present invention, specific restrictions are not imposed on the layout of the heater member 12, so long as both ends of the heater member 12 are connected to the lead wires 14. However, from the viewpoint of operability and productivity, it is preferable that the two lead wires 14 is placed at one end of the tape heater 10. For this reason, it is preferable that the heater member 12 is placed at the other end of the tape heater 10 in a folded manner, and that the entirety of the heater member is positioned in the shape of the letter “U”. In this case, an interval W2 between portions of the heater member 12 is determined appropriately in accordance with the width W1 of the fabric base 11. In the case of the previously-described width W1, the interval W2 may be set to 10 to 20 mm or thereabouts. A plurality of the heater member 12 may also be placed in the single tape heater 10.

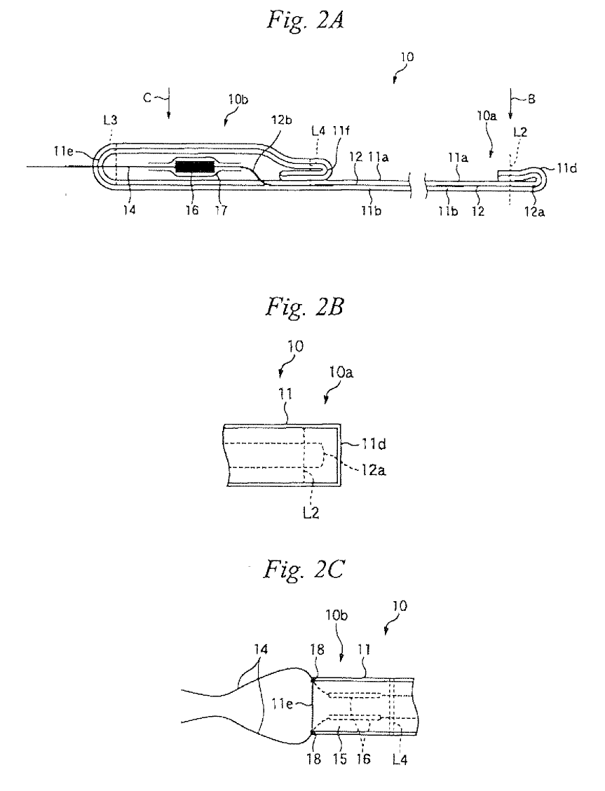

FIG. 2A is a cross-sectional view of the tape heater 10 taken along line B-B shown in FIG. 1, and only longitudinal ends of the tape heater are shown in an enlarged manner. FIG. 2B is a plan view of the tape healer when viewed in direction B in FIG. 2A. FIG. 2C is a plan view of the tape heater when viewed in direction C in FIG. 2A. As shown in FIGS. 2A and 2B, in the tape heater 10, an end 10a in a U-shaped portion 12a of the heater member 12 is folded along its brim, and a thus-folded portion 11d is stitched (L2), thereby preventing exposure of the heater member 12 from an extremity of the tape heater. According to the necessity, a heat-resistant tape may be wrapped around the entirety of the folded portion 11d.

As shown in FIGS. 2A and 2C, the other end 10b of the tape heater 10 is provided with a crimp portion 15 to which the heater member 12 and the lead wires 14 are to be connected. In the crimp portion 15, each of ends 12b of the heater member 12 are exposed to the outside by penetrating through the first fabric base part 11a and connected to crimp terminals 16, respectively. The lead wires 14 are connected to the ends through the crimp terminals 16. An area where there is a connection to the crimp terminals 16 is protected by being covered with a heat-shrinkable tube 17; for instance, a silicon vanish glass tube, or the like.

Moreover, the fabric base 11 is folded to a predetermined length so as to internally wrap the crimp portion 15. A folded portion 11e is stitched (L3), and an most extremity 11f of the folded portion 11e is folded to the inside and stitched (L4). The crimp portion 15 is thus protected reliably. Moreover, the lead wires 14 are drawn to the outside from both sides of the folded portion 11b. However, the lead wires are fixed by yarn (thread) 18 in such a way that force does not travel to the crimp terminals 16 when tensile force acts on the lead wires 14. According to the necessity, the entirety of the folded portion 11e may also be wrapped with a heat-resistant tape.

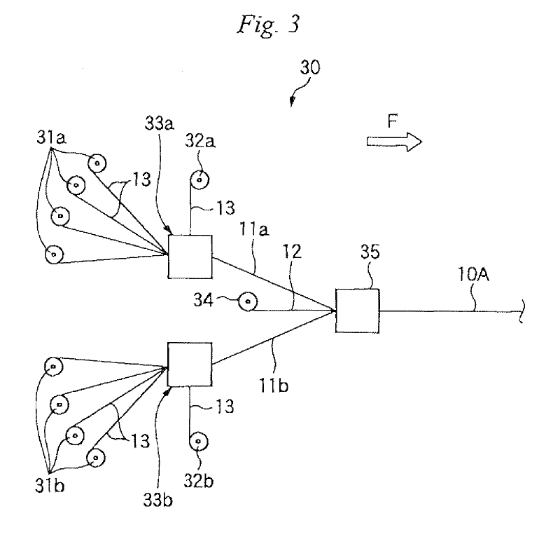

In order to manufacture the tape heater 10, a conventional knitting or weaving machine can be used. For instance, an apparatus 30 schematically shown in FIG. 3 is preferably used. The illustrated apparatus 30 has an first weaving machine 33a that weaves the first fabric base part 11a by supplying threads 13 from warp supply units 31a and a weft supply unit 32a; and a second weaving machine 33b that weaves the second fabric base part 11b by supplying the threads 13 from warp supply units 31b and a weft supply unit 32b (a step of forming fabric bases). A heater member supply unit 34 that supplies the heater member 12 is positioned downstream between the weaving machines 33a and 33b, and U-shaped portions 12a of the heater members 12 are oriented toward a weaving direction F (from the left side toward the right side in the drawing). Further, a sewing machine 35, that sews up the first and second fabric base parts 11a and 11b in die longitudinal direction thereof (a step of joining the fabric bases) while the heater member 12 is sandwiched between the first and second fabric bases 11a and 11b, is positioned downstream of the heater member supply unit 34 (a step of disposing a heater member). In the present invention, the step of forming fabric bases, the step of disposing the heater member, and the step of joining the fabric bases may also be continuously performed.

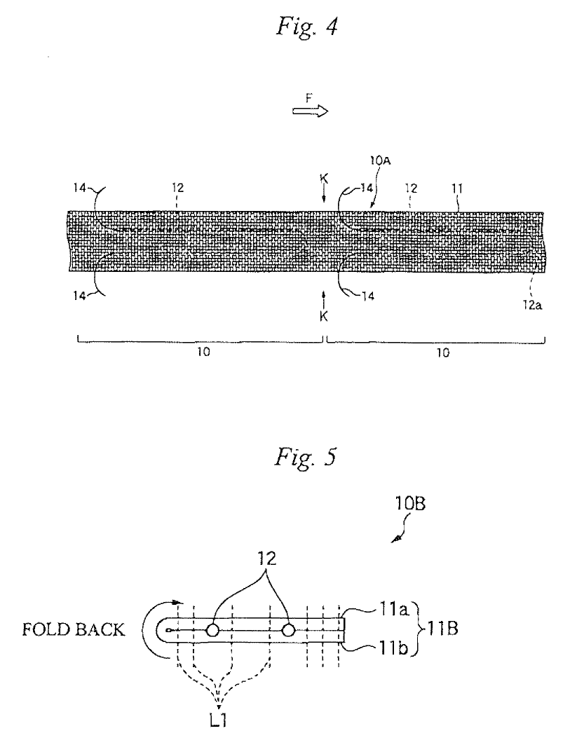

In the apparatus 30, the heater member 12 is supplied from the heater member supply unit 34 to a position between the first fabric base part 11a formed by the first weaving machine 33a and the second fabric base part 11b formed by the second weaving machine 33b. The sewing machine 35 sews up the first and second fabric base parts 11a and 11b while the heater member 12 is sandwiched between the first and second fabric base parts 11a and 11b. Accordingly, the first and second fabric base parts 11a and 11b are continually woven, and the heater member 12 is intermittently supplied. Thereby, there is produced a long tape heater precursor 10A having the heater members 12 sandwiched at predetermined intervals between the first and second fabric base parts 11a and 11b, such as that shown in FIG. 4.

The tape heater precursor 10A is cut along an intermediate point K between one heater member 12 and another heater member 12. The thus-separated respective precursors are subjected to edge processing shown in FIG. 2, whereby the tape heaters 10, such as those shown in FIG. 1, are produced.

### Second Embodiment

In the first embodiment, the fabric base 11 is formed from two of the first and second fabric base parts 11a and 11b. As shown in FIG. 5 (a cross section corresponding to FIG. 1B), there is provided a tape heater 10B in which the heater member 12 is sandwiched between the first and second fabric base parts 11a and 11b formed by folding back a single double-width fabric base 11B. In the tape heater 10B, a necessity for sewing up folded portions is obviated.

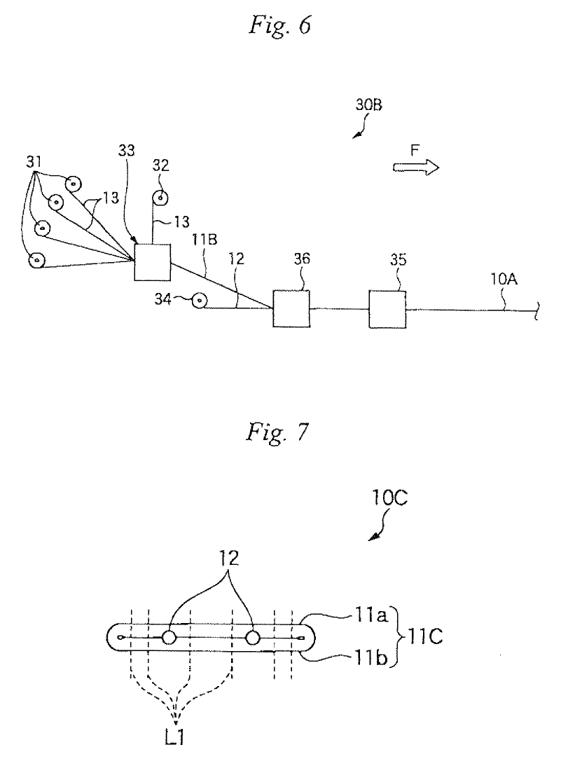

In order to manufacture the tape heater 10B, a conventional knitting or weaving machine can be used. For instance, an apparatus 30B schematically shown in FIG. 6 is preferably used. As illustrated, the apparatus 30B has a weaving machine 33 that weaves a single double-width fabric base 11B by supplying the threads 13 from the warp supply units 31 and the weft supply unit 32 (a step of forming a single fabric base). The heater member supply unit 34 that supplies the heater member 12 to an area corresponding to one-half the width of the fabric base 11B (an area which is to become the second fabric base part 11b later) is positioned downstream of the weaving machine 33. A fabric base folding machine 36 that folds the fabric base 11B, to thus form the first and second fabric base parts 11a and 11b, and that interposes the heater member 12 between the first and second fabric base parts 11a and 11b is positioned downstream of the heater member supply unit 34 (a step of folding a fabric base such that the heater member 12 is wrapped in). Further, the sewing machine 35 that sews up the thus-folded fabric base parts 11a and 11b in the longitudinal direction (a step of joining the fabric bases) is provided downstream the fabric base folding machine 36. In the present invention, the step of forming a single fabric base, the step of folding the fabric base so as to internally wrap the heater member 12, and the step of joining the fabric base may also be continuously performed.

Even in the present embodiment, a long tape heater precursor 10A, such as that shown in FIG. 4, is obtained. The thus-obtained tape precursor is cut, and the thus-separated sub-divisions are subjected to edge processing shown in FIG. 2, whereby the tape heaters 10B can be continually manufactured.

### Third Embodiment

As shown in FIG. 7 (a cross section corresponding to FIG. 1B), there is provided a tape heater 10C having the heater member 12 sandwiched by a tubular-knitted or tubular-woven fabric base 11C. In the tape heater 10C, a necessity for sewing up both ends of the fabric base 11C is obviated.

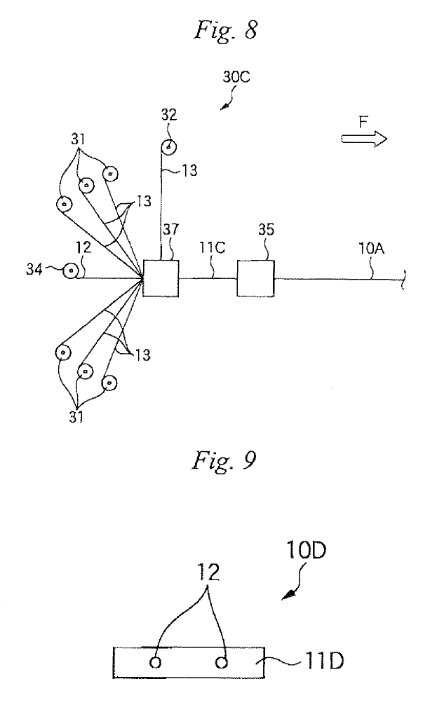

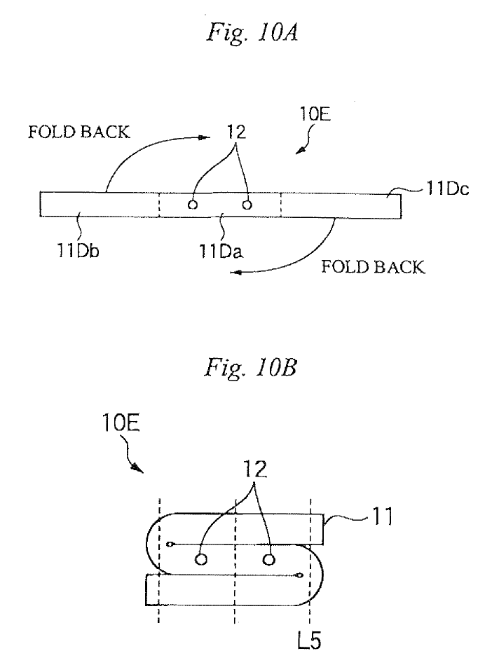

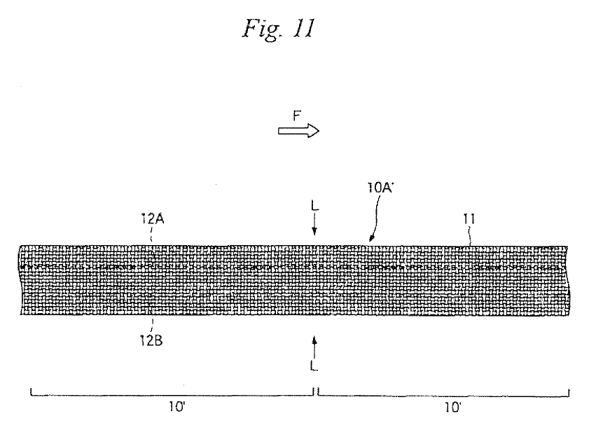

In order to manufacture the tape heater 10C, a conventional knitting or weaving machine can be used. For instance, an apparatus 30C schematically shown in FIG. 8 is preferably used. As illustrated, the apparatus 30C has a tubular weaving machine 37 that weaves a tubular fabric base 11C by supplying the threads 13 from the warp supply units 31 and the weft supply unit 32 (a step of forming a tubular fabric base). The tubular weaving machine 37 is supplied with the heater member 12 from the heater member supply unit 34, and the heater member 12 is disposed inside of the woven tubular fabric base 11C (a step of disposing a heater member inside of a tubular fabric base). The sewing machine 35 that flattens the tubular fabric base 11C, to thus form the first and second fabric base parts 11a and 11b, and that sews up the fabric base parts 11a and 11b in the longitudinal direction while the heater member 12 is sandwiched between the first and second fabric base parts 11a and 11b (a step of sewing up mutually-opposing faces of a tubular fabric base) is positioned downstream of the tubular weaving machine 37. In the present invention, the step of forming a tubular fabric base, the step of disposing the heater member inside of the tubular fabric base, and the step of joining mutually-opposing faces of the tubular fabric base may also be continuously performed.

Even in the present embodiment, the long tape heater precursor 10A, such as that shown in FIG. 4, is obtained. The thus-obtained heater precursor is cut, and the thus-cut sub-divisions are subjected to edge processing shown in FIG. 2, whereby the tape heaters 10C can be continually manufactured.

### Fourth Embodiment

As shown in FIG. 9 (a cross section corresponding to FIG. 1B), a tape heater 10D having the heater member 12 disposed in a flexible fabric base 11D formed by weaving a heat-resistant thread is provided. In the tape heater 10D, a necessity for sewing up both ends of the fabric base 11D and the heater member 12 (see; for instance, L1 in FIG. 1) is obviated. In order to manufacture the rape heater 10D, a conventional weaving machine can be used, and tee essential requirement is to include a step of forming a flexible fabric base while knitting heat-resistant threads and while internally wrapping the heater member 12.

### Fifth Embodiment

In the tape heater 10D of the fourth embodiment, the fabric base 11D is woven so as to have a triple width, and the heater member 12 is disposed in a center fabric base 11Da among trisected fabric bases. Both fabric bases 11Db and 11Dc on both sides of the center fabric base 11Da are folded so as to contact the both surfaces of the center fabric base 11Da, to thus form a three-layer structure. The thus-folded fabric base is sewed up over its entire thickness (L5), whereby a tape heater 10E can also be produced.

In the respective embodiments, there can also be produced a long tape heater precursor 10A′ in which two heater members 12A and 12B are disposed in parallel over the entire length of the fabric base 11, as shown in FIG. 11 (in correspondence with FIG. 4). The tape heater precursor 10A′ is cut into a required length (a cut location L). In each of separated pieces (10′, 10′), heater members 12A and 12B are pulled from one end of the fabric base 11 and connected together. Subsequently, the thus-connected heater members are housed in the fabric base 11, and an end 11A is sealed as shown in FIG. 2B. Further, a lead wire is connected to the other end of the fabric base 11 as shown in FIG. 2C, to thus produce a tape heater. By means of a long tape heater precursor 10A′, the length of the tape heater can be freely designed, and further enhancement of production efficiency and an additional reduction in production cost can be attained.

The invention was detailed with reference specified embodiments. However, it is obvious to a person skilled in the art that the invention may be variously modified and corrected without deviating from the spirit of the invention.

This application is based on Japanese Patent Application No. 2008-090706 flied on Mar. 31, 2008 and an entirety thereof is incorporated herein by reference.

Furthermore, all references cited here are incorporated by reference.

What is claimed is:

1. A tape heater comprising:
at least one flexible fabric base formed from a heat-resistant thread, the at least one flexible fabric base comprising a first fabric base part and a second fabric base part; and
a heater member,
wherein the heater member is interposed between the first fabric base part and the second fabric base part.

2. A tape heater comprising:
a flexible fabric base formed by weaving a heat-resistant thread; and
a heater member,
wherein the heater member is disposed in the fabric base.

3. The tape heater according to claim 1, wherein the fabric base is woven or knitted tubular fabric.

4. The tape hearer according to claim 1, wherein the thread comprises heat-resistant inorganic fibers.

5. The tape heater according to claim 2, wherein the thread comprises heat-resistant inorganic fibers.

6. The tape heater according to claim 1, wherein the heater member is formed by sheathing a heating wire with an electrically-insulative sleeve.

7. The tape heater according to claim 2, wherein the heater member is formed by sheathing a heating wire with an electrically-insulative sleeve.

8. A method for manufacturing a tape heater comprising:
a step of forming at least one flexible fabric base by knitting or weaving a heat-resistant thread, the at least one flexible fabric base comprising a first fabric base part and a second fabric base part;
a step of interposing a heater member between the first fabric base part and the second base part; and
a step of joining the fabric base(s).

9. A method for manufacturing a tape heater comprising:
a step of forming a flexible fabric base while weaving a heat-resistant thread and internally wrapping a heater member.

10. The method for manufacturing a tape heater according to claim 8, the fabric base is woven or knitted tubular fabric.

11. The method for manufacturing a tape heater according to claim 8, wherein knitting or weaving of the fabric base(s) is caused to proceed while the heater member is disposed, by continuously performing each of the steps.

12. The method for manufacturing a tape heater according to claim 10, wherein knitting or weaving of the fabric base is caused to proceed while the heater member is disposed, by continuously performing each of the steps.
